(19) United States
(12) Patent Application Publication
(10) Pub. No.: US 2008/0304267 A1
(43) Pub. Date: Dec. 11, 2008

(54) STATIONARY LED LAMP

(76) Inventor: Yu-Ho LIN, Nei-Pu Hsiang (TW)

Correspondence Address: SINORICA, LLC, 528 FALLSGROVE DRIVE, ROCKVILLE, MD, 20850, US

(21) Appl. No.: 11/759,822

(22) Filed: Jun. 7, 2007

(51) Int. Cl. F21V 29/00

(52) U.S. Cl. 362/294

(57) ABSTRACT

A stationary LED lamp includes a heat dissipating strip, a lamp cover base, a support strip, and an LED base. The heat-dissipating strip is adhered at an outer side of the lamp cover base, and the support strip is installed at an inner surface of the lamp cover base, which is provided with a reflecting strip on the inner surface. The LED base is provided with more than one LED welded on a PCB, and then adhered at an inner side of the support strip. Then the LED lamp is positioned by means of screwing or adhering, without easily loosening off as a conventional lamp does. The stationary LED lamp has a high luminance and swift heat dissipation to comply with the environment protection more effectively than the conventional one does.

### BACKGROUND OF THE INVENTION

1. Field of Invention

This invention relates to a stationary LED lamp, particularly to one making use of LED as a light source matched with a heat dissipating strip combined with a light cover base by adhering or screwing, not easily loosening off, saving electricity, having high efficacy so as to take place of conventional lights using rotation for stabilizing.

2. Description of the Related Art

Recently popular mobile houses are generally provided with conventional lamps such as fluorescent lamps that are stabilized in the base by rotation, More precisely, the two ends of a fluorescent lamp are first inserted in a lamp socket and then rotated to be stabilized therein, However, this kind of stabilizing a lamp is apt to let the lamp loosened, shift or even fall off by vibrations of a sport utility vehicle (SUV) during running on a road, Furthermore, the conventional lamp installed in the SUV is connected to the electricity of the engine, so the conventional lamp cannot have 100% effect in shining, in other words, too excessive power may be used in a wasted way, and it will become a large load for the engine if used for a long term. Thus the conventional lamp used in a SUV easily wears off, resulting in a short life, needing much expense for its repairing and maintaining for the owner.

### SUMMARY OF THE INVENTION

This invention has been devised to offer a stationary LED lamp, which is composed of a heat dissipating strip, a lamp cover base, a LED base, and a support strip. The heat dissipating strip, the lamp cover base and the support strip are all combined tightly together by means of screwing or adhering, The lamp over base is further provided with a reflecting strip on an inner surface and at least more than one LED welded with tin on a PCB (printed circuit board) fixed on the LED base. Then the LED base is adhered with the support strip with heat dissipating cream, with the two ends of the PCB connected with a power line so as to get exterior power.

### BRIEF DESCRIPTION OF THE DRAWINGS

The above and other objects of the present invention will become readily apparent by reference to the following detailed description when considered in conjunction with the accompanying drawings wherein:

FIG. 1 is a perspective view of a stationary LED lamp in the present invention.

FIG. 2 is an exploded perspective view of the stationary LED lamp in the present invention.

### DETAILED DESCRIPTION OF THE INVENTION

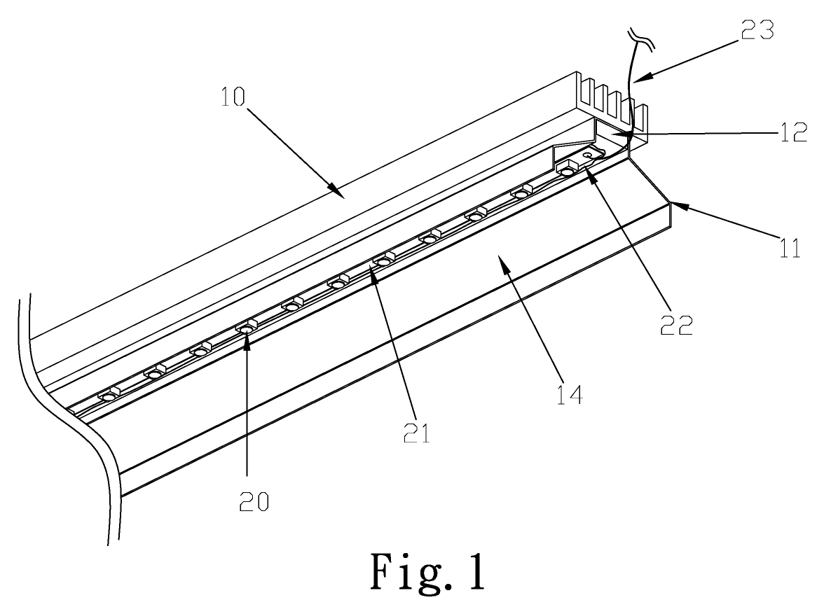

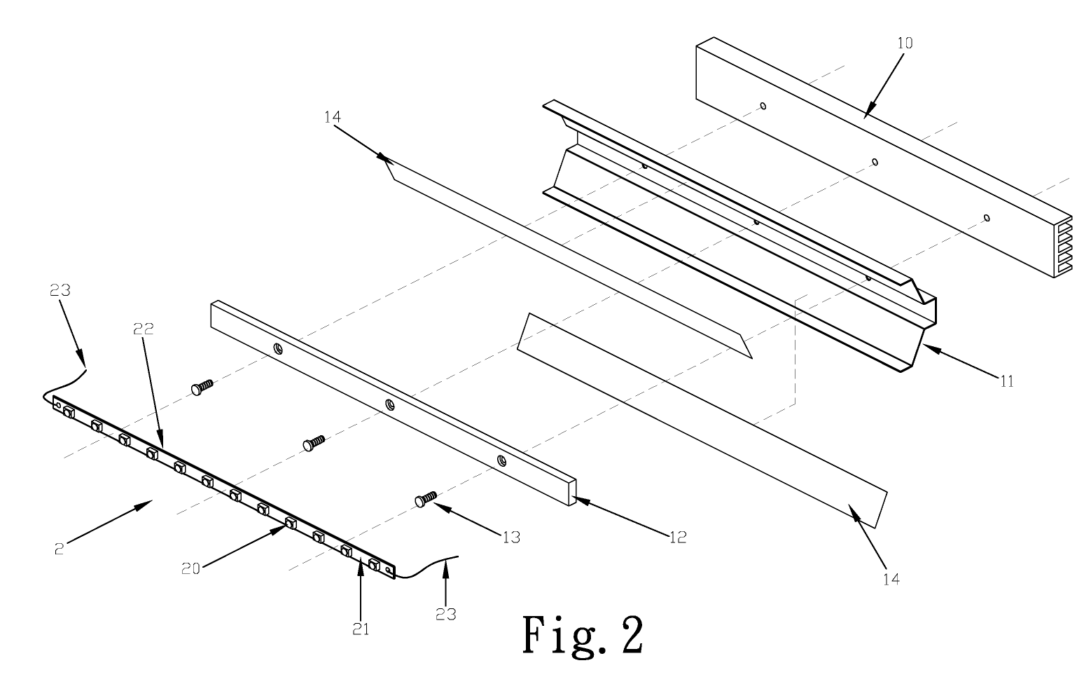

A preferred embodiment of a stationary LED lamp in the present invention, as shown in FIGS. 1 and 2, includes a heat dissipating strip 10, a lamp cover base 11, a support strip 11, and a lamp base 2 as main components combined together.

The heat dissipating strip 10, the lamp cover base 11 and the support strip are all provided with a plural screw holes properly spaced apart to correspond with each other, so screws 13 may screw up from below first through the screw holes of the support strip 12, then through the screw holes of the lamp cover base 11 and then with the screw holes of the heat dissipating strip 10. Thus the support strip 12, the lamp cover base 11 and the heat-dissipating strip 10 are combined together.

Next, the lamp cover base 11 has its inner surface adhered with a reflecting strip 14.

The LED base 2 has a thin PCB 21 strip made of metal, at least more than one LED 20 of high power welded on the PCB strip 21, which is then connected to the support strip 12 positioned in the lamp cover base 11 by means of heat dissipating cream 22. Then power lines 23 are connected to the two ends of the PCB 21, so exterior power can be used for the stationary LED lamp.

When the LED lamp is lit up, the reflecting strips 14 on the inner surface of the lamp cover base 11 can reflect the light of the LED 20, enhancing the luminance of the light for a large extent.

As for the heat-dissipating strip 10, the lamp cover base 11 and the support strip 12, they are all made of aluminum, or other metals having excellent property for heat dissipation. So after the three components 10, 11 and 12 are tightly combined together by screws 13, they will conduct heat quickly for dissipation so that the high heat generated by the LED 20 can be conducted by the PCB 21 and the heat dissipating cream 22 then dissipated swiftly through the support strip 12, lamp cover base 11 and the heat dissipating strip 10 orderly into the air. Therefore the heat of the LED 20 is lowered fast to enable the LED 20 work normally. In addition, the heat dissipating strip 10, the lamp cover base 11 and the support strip 12 can all be combined together by adhering instead of screwing, too.

Moreover, the LED 20 has not a few advantages, such as high effectiveness and high electrical saving, and low power consuming as low as ½- 1/10 of the conventional lamp such as fluorescent tubes or bulbs. So the LED 20 may have a service life of 50,000 hours, lasting for more than 17 years with 8 hours' use every day. Compared with the conventional lamp, the LED 20 can reduce the cost needed for maintenance and repair for a large extent, without using harmful metals like lead, or mercury often used in the conventional lamp as to give rise to environmental pollution.

The invention has the following advantages, as can be seen from the foresaid description.

1. As the LED lamp is combined together by means of adhering or screwing, it does not easily loosen or fall off as the conventional lamp that is stabilized by rotation, more stable and safe than the conventional ones.

2. The main components, the heat dissipating strip, the lamp cover base and the support strip, of the LED lamp are all made of metal having excellent heat conductivity, so the LED lamp is more heat-endurable and heat dissipating, with the high heat generated by it swiftly lowered down to enable the LED work always normally.

3. It can save electricity more than the conventional lamp, having a longer service life even for 17 years under normal use, reducing the lamp cost for a large extent.

4. It complies with the environmental protection, as it does not use heavy metals such as mercury as the conventional ones does to pollute the environment.

While the preferred embodiment of the invention has been described above, it will be recognized that various modifications may be made therein and the appended claims are intended to cover all such modifications that may fall within the spirit and scope of the invention.

It is readily apparent that the above-described embodiments have the advantage of wide commercial utility. It should be understood that the specific form of the invention hereinabove described is intended to be representative only, as certain modifications within the scope of these teachings will be apparent to those skilled in the art. Accordingly, reference should be made to the following claims in determining the full scope of the invention.

What is claimed is:

1. A stationary LED lamp comprising;
A heat-dissipating strip positioned at an outer side of an LED base;
A support strip fixed on an upper edge of an inner surface of said lamp cover base;
A lamp cover base installed at an inner side of said heat dissipating strip and having a reflecting strip adhered on its inner surface;
And said LED base installed at an outer surface of said support strip at the inner surface of said lamp cover base.

2. The stationary lamp as claimed in claim 1, wherein said LED base is provided with at least more than one LED welded on a PCB with tin, and said PCB is adhered on said support strip by means of heat dissipating cream.

3. The stationary LED lamp as claimed in claim 1, wherein said LED base is provided with at least more than one LED welded on a PCB with tin, and said PCB is screwed with said support strip.

4. The stationary LED lamp as claimed in claim 1, wherein said support strip, said lamp cover base and said heat dissipating strip are combined tightly together by means of screwing.

5. The stationary LED lamp as claimed in claim 1, wherein said support strip, said lam cover base, ad said heat dissipating strip are combined tightly together by means of adhering.

6. The stationary LED lamp as claimed in claim 1, wherein said support strip, said lamp cover base and said heat dissipating strip are formed integral.

7. The stationary LED lamp as claimed in claim 1, wherein said support strip, said lamp cover base, said heat dissipating strip and said PCB are all made of aluminum.

8. The stationary LED lamp as claimed in claim 1, wherein said support strip, said lamp cover base, said heat dissipating strip and said PCB are all made of metal alloy.

9. The stationary LED lamp as claimed in claim 1, wherein said support strip, said lamp cover base, said heat dissipating strip and said PCB are all made of porcelain.
